(19) United States
(12) Patent Application Publication
(10) Pub. No.: US 2023/0351567 A1
(43) Pub. Date: Nov. 2, 2023

(54) DATA PROCESSING DEVICE AND DATA PROCESSING METHOD

(71) Applicant: NEC Corporation, Minato-ku, Tokyo (JP)

(72) Inventors: Taichi TANAKA, Tokyo (JP); Osamu HOSHUYAMA, Tokyo (JP)

(73) Assignee: NEC Corporation, Minato-ku, Tokyo (JP)

(21) Appl. No.: 17/909,637

(22) PCT Filed: Mar. 17, 2020
(86) PCT No.: PCT/JP2020/011744

§ 371 Date: Sep. 6, 2022

(51) Int. Cl. G06T 5/50; G06T 7/00; G01S 13/90; G06T 5/00

(52) U.S. Cl. CPC G06T 5/50; G06T 7/97; G01S 13/9021; G06T 5/002; G06T 2207/20221

(57) ABSTRACT

The data processing device 1 includes a coherence matrix calculation unit 2 which calculates a coherence matrix representing correlation of pixels at the same position in multiple complex images, a spatial correlation generator 3 which generates data representing prior information regarding spatial correlation being correlation of pixels in each of the multiple complex images, and a phase difference estimation unit 4 which merges the correlation of pixels regarding the coherence matrix and the spatial correlation, and calculates a statistically likely and consistent phase difference based on merged correlation as a denoised phase difference.

### TECHNICAL FIELD

This invention relates to a data processing device and a data processing method applicable to an image analysis system that performs image analysis based on phases of received electromagnetic waves from a synthetic aperture radar.

### BACKGROUND ART

Synthetic aperture radar (SAR) technology is a technology which can obtain an image equivalent to the image by an antenna having a large aperture, when a flying object such as artificial satellite, aircraft, or the like transmits and receives a radio wave while the flying object moves. The synthetic aperture radar is utilized, for example, for analyzing an elevation or a ground surface deformation by signal-processing reflected waves from the ground surface, etc. In particular, when accuracy is required, the analyzer takes time-series SAR images (SAR data) obtained by a synthetic aperture radar as input, and performs time-series analysis of the input SAR images.

Interferometric SAR analysis is an effective method for analyzing an elevation or a ground surface deformation. In the interferometric SAR analysis, the phase difference between radio signals of plural (for example, two) SAR images taken at different times is calculated. Based on the phase difference, a change in distance between the flying object and the ground that occurred during the shooting time period is detected.

Patent literature 1 describes an analysis method that uses a coherence matrix. The coherence matrix represents correlation of pixels at the same position in multiple complex images.

The coherence is calculated by complex correlation of pixels at the same position in plural SAR images among N (N≥2) SAR images. Suppose that (m, n) is a pair of SAR images and c_{m, n,} are components of the coherence matrix. Respective m and n are less than or equal to and indicate one of the N SAR images. The phase θ_{m, n,} (specifically, the phase difference) is calculated for each pair of SAR images. Then, an absolute value of the value obtained by averaging exp(−jθ_{m, n}) for a plurality of pixels in a predetermined area including pixels to be calculated as coherence is the component c_{m, n} of the coherence matrix. In addition, Aₘ·Aₙ·exp(−jθ_{m, n}) may be averaged, where intensity in SAR image m is as Aₘ and intensity in SAR image n is as Aₙ.

The magnitude of the variance of the phase θ_{m, n} can be grasped from the absolute value of c, i.e., ||c_{m, n}||.

The coherence matrix contains information, such as variance, that allows estimation of the degree of phase noise amount.

The fact that phase θ_{m, n} is correlated with displacement velocity and shooting time difference is used for displacement analysis of the ground surface and other objects. For example, the displacement is estimated based on the average value of the phase difference. It is possible to verify the accuracy of the displacement analysis using the amount of phase noise. Thus, the coherence matrix can be used for the displacement analysis.

For elevation analysis, the correlation of phase θ_{m,n} to the elevation of the object being analyzed and the distance between the flying objects (for example, the distance between the two shooting positions of the flying objects) is used. For example, the elevation is estimated based on the average value of the phase difference. The amount of phase noise can be used to verify the accuracy of the elevation analysis. Thus, the coherence matrix can be used for elevation analysis.

Patent literature 1 describes a method of fitting a model such as displacement to a coherence matrix and recovering the phase excluding the effect of noise. A similar method is also disclosed in non-patent literature 1.

### CITATION LIST

### Patent Literature

PTL 1: International Publication No. 2011/003836

### Non Patent Literature

NPL 1: A. M. Guarnieri et. al, “On the Exploitation of Target Statistics for SAR Interferometry Applications”, IEEE Transactions on Geoscience and Remote Sensing, Vol. 46, No. 11, pp. 3436-3443, November 2008

### SUMMARY OF INVENTION

### Technical Problem

According to the method described in patent literature 1 and the method described in non-patent literature 1, noise included in the phase difference can be reduced. However, when displacement analysis and elevation analysis are performed, since it is desirable that as little noise as possible be included in the phase difference, more noise is desired to be removed.

It is an object of the present invention to provide a data processing device and a data processing method that can achieve a greater degree of phase noise reduction.

### Solution to Problem

The data processing apparatus according to the present invention includes coherence matrix calculation means for calculating a coherence matrix representing correlation of pixels at the same position in multiple complex images, spatial correlation generation means for generating data representing prior information regarding spatial correlation being correlation of pixels in each of the multiple complex images, and phase difference estimation means for merging the correlation of pixels regarding the coherence matrix and the spatial correlation, and calculating a statistically likely and consistent phase difference based on merged correlation as a denoised phase difference.

The data processing method according to the invention includes calculating a coherence matrix representing correlation of pixels at the same position in multiple complex images, generating data representing prior information regarding spatial correlation being correlation of pixels in each of the multiple complex images, and merging the correlation of pixels regarding the coherence matrix and the spatial correlation, and calculating a statistically likely and consistent phase difference based on merged correlation as a denoised phase difference.

The data processing program according to the present invention causes a computer a process of calculating a coherence matrix representing correlation of pixels at the same position in multiple complex images, a process of generating data representing prior information regarding spatial correlation being correlation of pixels in each of the multiple complex images, a process of merging the correlation of pixels regarding the coherence matrix and the spatial correlation, and calculating a statistically likely and consistent phase difference based on merged correlation as a denoised phase difference.

### Advantageous Effects of Invention

According to the present invention, the degree of phase noise reduction can be greater.

### BRIEF DESCRIPTION OF DRAWINGS

FIG. 1 It depicts a block diagram showing a configuration example of the data processing device of the first example embodiment.

FIG. 2 It depicts an explanatory diagram for explaining consistent phase.

FIG. 3 It depicts a flowchart showing an example of an operation of the data processing device of the first example embodiment.

FIG. 4 It depicts a block diagram showing a configuration example of the data processing device of the second example embodiment.

FIG. 5 It depicts a flowchart showing an example of an operation of the data processing device of the second example embodiment.

FIG. 6 It depicts a block diagram showing a configuration example of the data processing device of the third example embodiment.

FIG. 7 It depicts a flowchart showing an example of an operation of the data processing device of the third example embodiment.

FIG. 8 It depicts a block diagram showing a configuration example of the data processing device of the fourth example embodiment and the fifth example embodiment.

FIG. 9 It depicts a flowchart showing an example of an operation of the data processing device of the fourth example embodiment and the fifth example embodiment.

FIG. 10 It depicts a block diagram showing a configuration example of the data processing device of the sixth example embodiment.

FIG. 11 It depicts a flowchart showing an example of an operation of the data processing device of the sixth example embodiment.

FIG. 12 It depicts a block diagram showing a configuration example of the data processing device of the seventh example embodiment.

FIG. 13 It depicts a flowchart showing an example of an operation of the data processing device of the seventh example embodiment.

FIG. 14 It depicts a block diagram showing an example of a computer with a CPU.

FIG. 15 It depicts a block diagram showing the main part of the data processing device.

FIG. 16 It depicts a block diagram showing the main part of another type of the data processing device.

### EXAMPLE EMBODIMENTS

Hereinafter, example embodiments of the present invention will be described with reference to the drawings.

### Example Embodiment 1

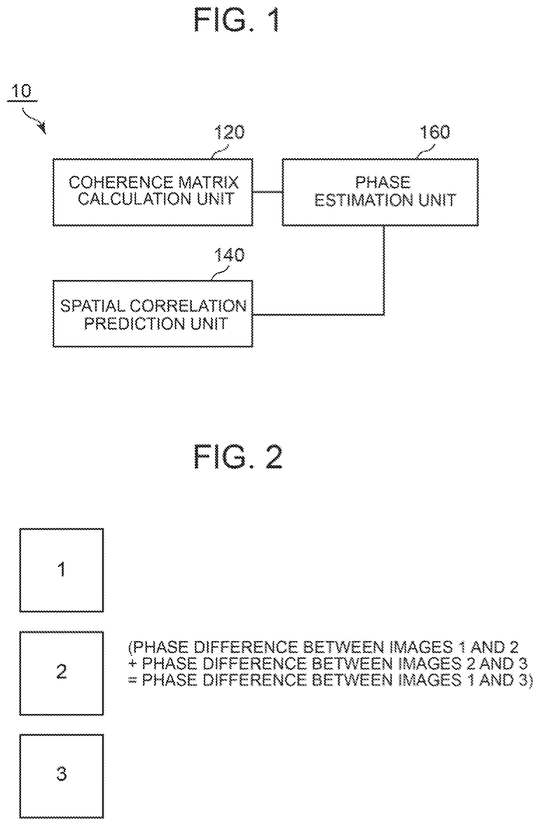

FIG. 1 is a block diagram showing a configuration example of the data processing device of the first example embodiment. The data processing device 10 shown in FIG. 1 includes a coherence matrix calculation unit 120, a spatial correlation prediction unit 140, and a phase estimation unit 160. The data processing device 10 can obtain a phase (specifically, a phase difference) with reduced phase noise.

For example, when the coherence matrix is calculated from SAR images, N (N≥3) SAR images (complex images: including amplitude and phase information) are stored in a SAR image storage (not shown). The coherence matrix calculation unit 120 calculates coherence matrix using the pixel phases. The spatial correlation prediction unit 140 predicts the correlation coefficients of pixels in an image and generates a spatial correlation matrix whose elements are correlation coefficients. The phase estimation unit 160 estimates consistent phase (specifically, the phase difference) based on the coherence matrix while considering the spatial correlation matrix.

In the first example embodiment, as an example, the coherence matrix calculation unit 120 calculates a coherence matrix from the SAR image stored in the SAR image storage, however, as described below, it is merely one case that the coherence matrix calculation unit 120 calculates a coherence matrix from the SAR image stored in the SAR image storage. The coherence matrix calculation unit 120 can also calculate a coherence matrix using other information (data).

It should be noted that that “consistent phase” means that the values of the calculation results are consistent when the phase difference is recalculated from any other combination of phase differences (any combination of phase differences).

FIG. 2 an explanatory diagram for explaining consistent phase. Three SAR images are illustrated in FIG. 2. The numbers inside of rectangles showing SAR images indicate the image numbers. For example, when the phase difference between image 3 and image 1 is equal to the sum of the phase difference between image 1 and image 2, and the phase difference between image 2 and image 3, i.e., when the equation below is satisfied, the state of “consistent phase” has been achieved in images 1-3. In the following equation, for example, (φ_{a-b} indicates the phase difference between image a and image b. In the example shown in FIG. 2, a=1, b=2, and c=3 in the equation below. The phase difference between the two SAR images means a phase difference between corresponding pixels in each image.

φ_{a-b}+φ_{b-c}=φ_{c-a}

Since the phases are the same even if there is a difference of an integer multiple of 2π, due to the characteristics of the phase, a consistent phase can be considered to have been achieved when the following equation is satisfied. In the following equation, k is an arbitrary integer.

φ_{a-b}+φ_{b-c}=φ_{c-a}+2kπ

When the above equation is satisfied for all of the N images, then the phase in the SAR image is in a state of “consistent phase”. Hereafter, the fact that the above equation is satisfied may be referred to as satisfying the constraint.

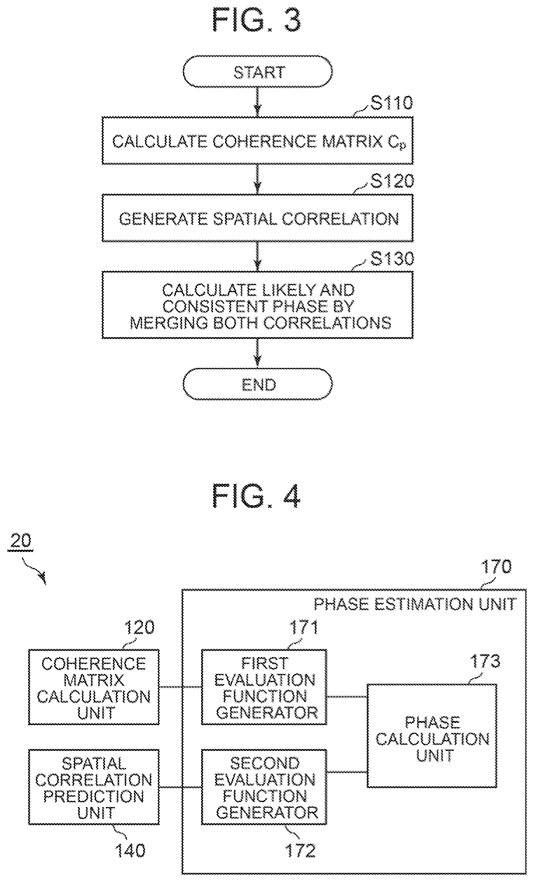

Next, the operation of the data processing device 10 shown in FIG. 1 will be described with reference to the flowchart in FIG. 3.

The coherence matrix calculation unit 120 calculates a coherence matrix Cₚ for N SAR images stored in the SAR image storage, for example. The coherence matrix Cₚ is calculated for the N SAR images stored in the SAR image storage (step S110). As described above, for example, suppose that (m, n) is a pair of SAR images and c_{m,n,} is a component of the coherence matrix Cₚ. m, n are values less than or equal to N, respectively, and indicate one of the N SAR images. The coherence matrix calculation unit 120 calculates the phase θ_{m,n} (specifically, the phase difference) for the pair of SAR images. Then, the coherence matrix calculation unit 120 sets the value obtained by averaging exp(−jθ_{m, n}) for a plurality of pixels in a predetermined area including pixels to be calculated as coherence to the component c_{m, n} of the coherence matrix Cₚ.

The coherence matrix calculation unit 120 may obtain the coherence matrix by averaging Aₘ,Aₙexp (−jθ_{m,n}) that includes intensity Aₘ and Aₙ. When assuming that the coherence matrix obtained in this way with the intensity is Γ, the coherence matrix calculation unit 120 may recalculate a coherence matrix in a manner that is not affected by the average intensity by multiplying all the elements of the matrix by a constant so that an average of the diagonal components becomes to be 1. The coherence matrix calculation unit 120 may also multiply the coherence matrix Γ obtained in the intensity-included manner by a diagonal matrix from the left and right of Γ so that all diagonal components become to be 1. The coherence matrix calculation unit 120 may also estimate how much noise is applied by which pair of shooting conditions based on information other than SAR, such as whether the area to be analyzed includes vegetation or concrete artificial structures, or shooting conditions under which each of the input SAR images was taken, to define a coherence matrix.

The spatial correlation prediction unit 140 generates (calculates) spatial correlation (correlation of pixels in the area to be analyzed) based on prior information (known data) regarding the area to be analyzed in the SAR image (which may be the entire area) (step S120). It should be noted that the execution order of step S110 and step S120 is not limited to the order shown in FIG. 3. For example, the process of step S120 may be executed before the process of step S110, or both processes may be executed at the same time.

The spatial correlation is given to the data processing device 10 in advance, and is represented by a spatial correlation matrix K whose elements are correlation coefficients, for example. However, the spatial correlation matrix K is an example of a representation of spatial correlation, and other representations may be used. The following information, for example, is illustrated as prior information.

The schematic shape of the object to be analyzed (for example, a structure that is the object of displacement analysis) in the image analysis system to which the data processing system 10 is applied. As an example, when the object is a long and narrow shaped structure such as a steel tower, the spatial correlation is generated so that the pixels are smoothly correlated in the extending direction of the structure.
Weights in the graph (nodes: pixels, edges (weights): correlations) for which the correlations are known. When using this prior information, a spatial correlation matrix K whose elements are values based on the weights is generated.
Information obtained from SAR images obtained in the past. That is, the correlation of pixels in known images of the area to be analyzed.

Prior information is not limited to the above examples, but can be other types of information as long as the spatial correlation of the object to be analyzed can be predicted.

The phase estimation unit 160 calculates a statistically likely and consistent phase (specifically, phase difference) by merging both correlations (step S130).

In the first example embodiment, phase noise can be reduced more effectively because the process of removing phase noise takes into account correlation of pixels in the SAR image.

### Example Embodiment 2

FIG. 4 is a block diagram showing a configuration example of the data processing device of the second example embodiment. The data processing device 20 shown in FIG. 4 includes the coherence matrix calculation unit 120, the spatial correlation prediction unit 140, and a phase estimation unit 170. The phase estimation unit 170 includes a first evaluation function generator 171, a second evaluation function generator 172, and a phase calculation unit 173.

The data processing device 20 of the second example embodiment corresponds to a data processing device in which the data processing device 10 of the first example embodiment shown in FIG. 1 is embodied.

In the second example embodiment, as an example, the coherence matrix calculation unit 120 also calculates a coherence matrix from the SAR image stored in the SAR image storage (not shown). However, the coherence matrix calculation unit 120 can calculate a coherence matrix using other information (data) instead of calculating the coherence matrix from the SAR image stored in the SAR image storage.

The first evaluation function generator 171 inputs the coherence matrix Cp and generates a first evaluation function (observed signal evaluation function). The observed signal evaluation function is an evaluation function based on an observed signal associated with the coherence matrix Cₚ and noise-free phase.

The second evaluation function generator 172 inputs the spatial correlation (for example, spatial correlation matrix K) and generates a second evaluation function (spatial correlation evaluation function) representing smooth distribution of phase differences in an image. In other words, the second evaluation function generator 172 generates a spatial correlation evaluation function that includes information (data) representing how smooth the phase should be calculated spatially.

The phase calculation unit 173 calculates phase that is estimated to be noise-free using the observed signal evaluation function and the spatial correlation evaluation function.

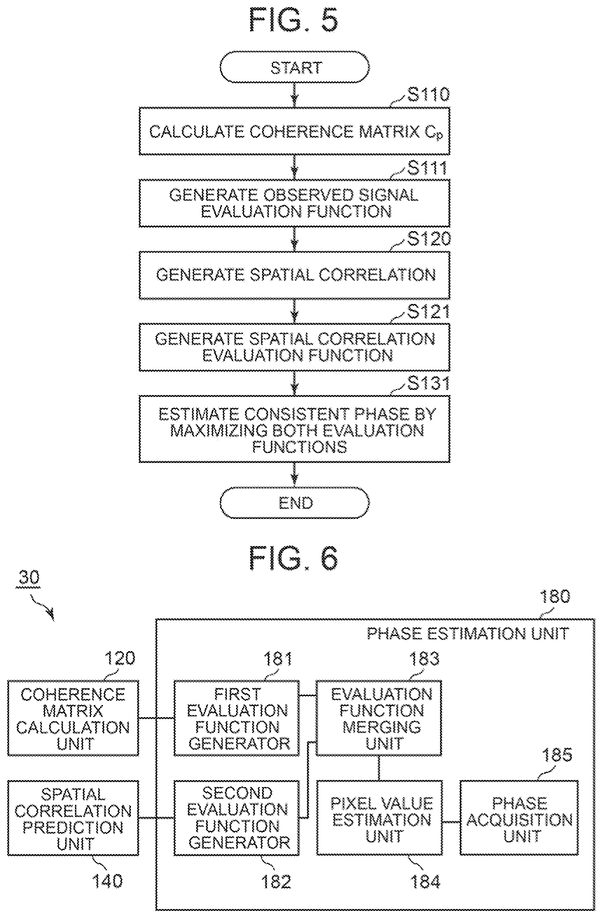

Next, the operation of the data processing device 20 shown in FIG. 4 will be described with reference to the flowchart in FIG. 5.

The coherence matrix calculation unit 120 calculates the coherence matrix Cₚ for N SAR images stored in the SAR image storage as in the first example embodiment (step S110).

In the phase estimation unit 170, the first evaluation function generator 171 generates an observed signal evaluation function (step S111). That is, the first evaluation function generator 171 generates an evaluation function for evaluating correlation with the observation function for the phase difference from which noise has been removed.

The spatial correlation prediction unit 140 generates (calculates) spatial correlation based on prior information regarding the area to be analyzed in the SAR image as in the first example embodiment (step S120). In the second example embodiment, the case in which the spatial correlation prediction unit 140 generates a spatial correlation matrix K is used as an example.

In the phase estimation unit 170, the second evaluation function generator 172 generates a spatial correlation evaluation function (step S121). That is, the second evaluation function generator 172 generates an evaluation function for evaluating the degree of conformity between spatial correlation of the phase difference from which noise has been removed and spatial correlation matrix K.

In the phase estimation unit 170, the phase calculation unit 173 estimates a consistent phase difference by maximizing both the observed signal evaluation function and the spatial correlation evaluation function (step S131).

In the second example embodiment, phase noise can be reduced more effectively because the process of removing phase noise also uses the spatial correlation evaluation function of the pixels in the SAR image.

### Example Embodiment 3

FIG. 6 is a block diagram showing an example configuration of the data processing device of the third example embodiment. The data processing device 30 shown in FIG. 6 includes the coherence matrix calculation unit 120, the spatial correlation prediction unit 140, and a phase estimation unit 180. The phase estimation unit 180 includes a first evaluation function generator 181, a second evaluation function generator 182, an evaluation function merging unit 183, a pixel value estimation unit 184, and a phase acquisition unit 185.

The data processing device 30 of the third example embodiment corresponds to a data processing device in which the data processing device 20 of the second example embodiment shown in FIG. 4 is more embodied.

In the third example embodiment, as an example, the coherence matrix calculation unit 120 also calculates a coherence matrix from the SAR image stored in the SAR image storage (not shown). However, the coherence matrix calculation unit 120 can calculate a coherence matrix using other information (data) instead of calculating the coherence matrix from the SAR image stored in the SAR image storage.

The first evaluation function generator 181 inputs the coherence matrix Cₚ and generates a first evaluation function (observed signal evaluation function). In the third example embodiment, the evaluation function of equation (1) is used as the observed signal evaluation function. When the operation on the right side of equation (1) is performed, the operation using the inverse matrix of C (corresponding to the coherence matrix) is performed. The inverse matrix of C corresponds to weights based on the coherence matrix.

[Math. 1]

p(y·_{,p}|Cₚ,x·_{,p})=N(y·_{,p}|0,Cₚ∘x·_{,p}x·_{,p}^{H}) (1)

The second evaluation function generator 182 inputs the spatial correlation matrix K and generates a second evaluation function (spatial correlation evaluation function) representing smooth distribution of phase differences in an image. In the third example embodiment, the evaluation function of equation (2) is used as the spatial correlation evaluation function. When the operation on the right side of equation (2) is performed, the operation using the inverse matrix of the spatial correlation matrix K is performed. The inverse matrix of the spatial correlation matrix K corresponds to weights based on prior information.

[Math. 2]

p(x_{n,}^{H}·|K)=N(x_{n,}^{H}·|0,K) (2)

The evaluation function merging unit 183 merges the observed signal evaluation function and the spatial correlation evaluation function. In the third example embodiment, the evaluation function of equation (3) is used as the merged evaluation function.

[Math. 3]

Πₚp(y·_{,p}|Cₚ,x·_{,p})Πₙp(x_{n,}^{H}·|K) (3)

In equations (1) to (3), y_{n,p} indicates a pixel value at the position p (pixel p) in the nth (n: 1 to N) image. x_{n,p} indicates the pixel value without noise (pixel value with noise removed) at the position p (pixel p) in the nth image. “H” denotes the complex conjugate transpose.

“·” (for example, “·” in y·_{, p}) indicates all elements (for example, y is a vector whose elements are y₁−y_{N1}). Thus, for example, when p=1, y·, p is a row vector whose elements are y₁₁, y₂₁, . . . , y_{N1}.

In the observed signal evaluation function of equation (1), Cₚ is a coherence matrix at pixel p. N on the right side is the probability density function in the complex normal distribution. On the right side of the vertical line indicating a condition (constraint), “0” is the mean value. x·_{,p}x·^{H}_{,p} on the right side of the “^{∘}” indicating the Hadamard product corresponds to the phase difference at pixel p in an observed image. The result of the Hadamard product corresponds to the variance-covariance matrix.

In the spatial correlation evaluation function of equation (2), x^{H}_{n,}· represents a value of each pixel (when noise is removed) for each image n (n: 1 to N). Since the spatial correlation (specifically, the spatial correlation matrix K) is set to the right of the vertical line indicating the condition (constraint), x^{H}_{n,}· follows spatial correlation.

In equation (3), Π denotes the production. Therefore, the evaluation function of equation (3) corresponds to the product of the observed signal evaluation function and the spatial correlation evaluation function for all pixels in all images (N images). Then, the pixel value estimation unit 184 finds x that maximizes the evaluation function of equation (3). Finding x that maximizes the evaluation function corresponds to increasing correlation between the phase based on the observed pixel value and the denoised phase difference, and correlation between pixels after denoising, under the weight based on the coherence matrix and the weight based on the prior information.

Further, the phase difference between the image m and the image n is obtained as shown in (4). That is, the phase acquisition unit 185 obtains the phase difference based on a product of the pixel value in image m and the complex conjugate of the pixel value of the corresponding pixel in image n.

[Math. 4]

x_{m,p}x̅_̅{̅n̅,̅p̅}̅ (4)

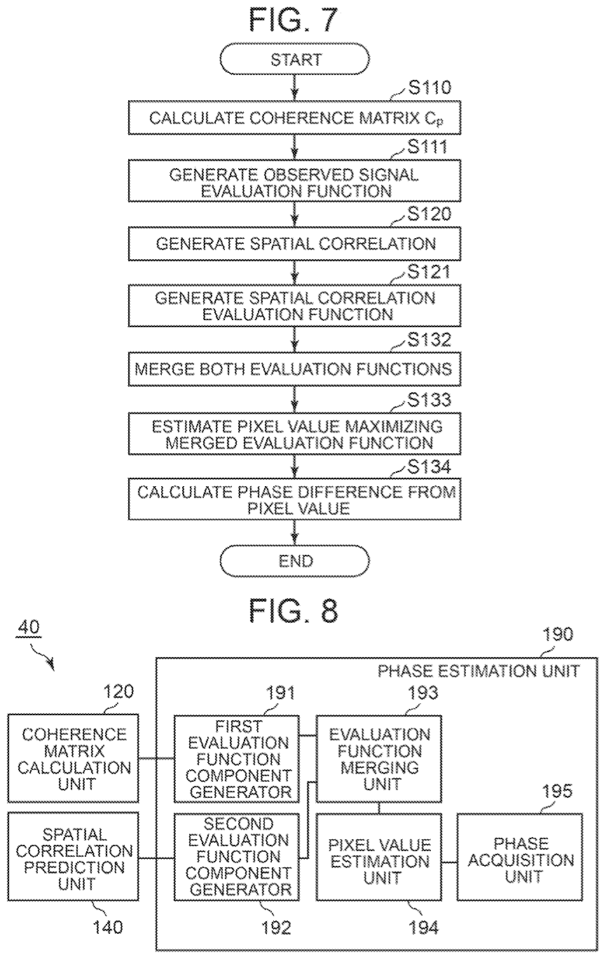

Next, the operation of the data processing device 30 shown in FIG. 6 will be described with reference to the flowchart in FIG. 7.

The coherence matrix calculation unit 120 calculates the coherence matrix Cₚ for N SAR images stored in the SAR image storage as in the second example embodiment (step S110).

In the phase estimation unit 180, the first evaluation function generator 181 generates an observed signal evaluation function (step S111). That is, the first evaluation function generator 181 generates the evaluation function of equation (1).

The spatial correlation prediction unit 140 generates (calculates) spatial correlation (in this example, a spatial correlation matrix K) based on prior information regarding the area to be analyzed in the SAR image as in the second example embodiment (step S120).

In the phase estimation unit 180, the second evaluation function generator 182 generates a spatial correlation evaluation function (step S121). That is, the second evaluation function generator 182 generates the evaluation function of equation (2).

The evaluation function merging unit 183 merges the observed signal evaluation function and the spatial correlation evaluation function (step S132). That is, the evaluation function merging unit 183 generates the evaluation function of equation (3). The pixel value estimation unit 184 finds x that maximizes the evaluation function of equation (3) (step S133).

The phase acquisition unit 185 obtains a product of the pixel value in image m and the complex conjugate of the pixel value of the corresponding pixel in image n (refer to (4)), and obtain the phase difference based on the obtained product (step S134). Specifically, the phase acquisition unit 185 obtains the argument of the product (complex conjugate) as the phase difference.

In the third example embodiment, the constraint regarding “consistent phase” is satisfied by estimating the phase difference based on the pixel value x after the pixel value x is calculated. Specifically, the constraint is satisfied because the phase difference is calculated again after a certain phase value is assigned to each image.

### Example Embodiment 4

FIG. 8 is a block diagram showing an example configuration of the data processing device of the fourth example embodiment. The data processing device 40 shown in FIG. 8 includes the coherence matrix calculation unit 120, the spatial correlation prediction unit 140, and a phase estimation unit 190. The phase estimation unit 190 includes a first evaluation function component generator 191, a second evaluation function component generator 192, an evaluation function merging unit 193, a pixel value estimation unit 194, and a phase acquisition unit 195.

In the fourth example embodiment, as an example, the coherence matrix calculation unit 120 also calculates a coherence matrix from the SAR image stored in the SAR image storage (not shown). However, the coherence matrix calculation unit 120 can calculate a coherence matrix using other information (data) instead of calculating the coherence matrix from the SAR image stored in the SAR image storage.

In the phase estimation unit 190, the first evaluation function component generator 191 and the second evaluation function component generator 192 perform different processing from processing of the first evaluation function generator 181 and the second evaluation function generator 182 in the third example embodiment. That is, the first evaluation function component generator 191 generates the matrix, for performing evaluation with respect to the observed signal, which is the second term on the right side of in the equation (5). The second evaluation function component generator 192 generates the matrix, for evaluating the spatial correlation, which is the first term on the right side of in the equation (5). In equation (5), the inverse matrix of Cₚ corresponds to weights based on the coherence matrix. The inverse of the spatial correlation matrix K corresponds to weights based on the prior information.

[Math. 5]

Λ=(I_{N}⊗K⁻)+Σₚ(I_{N}⊗eₚ)(Cₚ⁻¹∘y·_{,p}y·_{,}^{H})(I_{N}⊗eₚ^{T}) (5)

In equation (5), y_{n,p} indicates a pixel value at the position p (pixel p) in the nth (n: 1 to N) image. However, the observed pixel value may be multiplied by a real number in each image and each pixel so that the absolute value is 1 in all pixels of all images. Each pixel may also be multiplied by a real number common to all images so that an average of the absolute values or an average of the squares of the absolute values for the pixel across all images is 1. In equation (5), x_{n,p} indicates the pixel value without noise at the position p (pixel p) in the nth image.

“·” (for example, “·” in y·_{,p}) indicates all elements (for example, y· is a vector whose elements are y₁−y_{N}). Thus, for example, when p=1, y·_{,p} is a column vector whose elements are y₁₁, y₂₁, . . , y_{N1}. It should be noted that “x_{n,}·” is a column vector in which values, taken from x, corresponding to all pixels p for image n are arranged in the column direction.

I_{N} is an N×N identity matrix. eₚ is a column vector with p-th row of 1 and other rows of 0. A symbol with an X in a circle indicates the Kronecker product. “T” denotes transpose.

It should be noted that the matrix generated by equation (5) is integrated by being multiplied with vec(x) in the form of equation (6) below to evaluation function for x. Such an evaluation function is equivalent to an evaluation function which is logarithm of the evaluation function of equation (3) in the third example embodiment and is added a negative sign to, i.e., an evaluation function in which the x-dependent part of the negative log likelihood is expressed in matrix form. It corresponds to the evaluation function in which the x-dependent part of the negative log likelihood is expressed in matrix form. Therefore, maximization in equation (3) is equivalent to minimization in the evaluation equation (6).

[Math. 6]

vec(x)^{H}Λvec(x) (6)

The evaluation function merging unit 193 generates an evaluation function based on the matrix according to equation (5). The pixel value estimation unit 194 obtains x that minimizes the evaluation function. The phase acquisition unit 195 obtains the phase difference based on x.

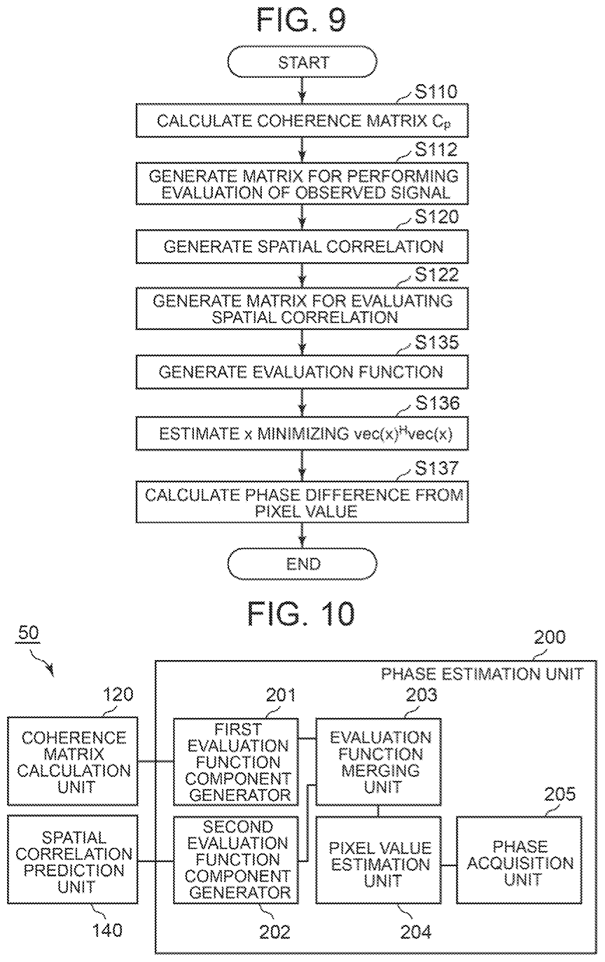

Next, the operation of the data processing device of the fourth example embodiment will be described with reference to the flowchart in FIG. 9.

The coherence matrix calculation unit 120 calculates the coherence matrix Cp for N SAR images stored in the SAR image storage as in the third example embodiment (step S110).

In the phase estimation unit 180, the first evaluation function component generator 191 generates a matrix for performing evaluation with respect to the observed signal (step S112). The first evaluation function component generator 191 generates the matrix of the second term on the right side of the equation (5) in the process of step 112.

T the spatial correlation prediction unit 140 generates (calculates) spatial correlation (in this example, a spatial correlation matrix K) based on prior information regarding the area to be analyzed in the SAR image as in the first example embodiment (step S120).

In the phase estimation unit 180, the second evaluation function component generator 192 generates a matrix for evaluating spatial correlation (step S122). The second evaluation function component generator 192 generates the matrix of the first term on the right side of equation (5).

The evaluation function merging unit 193 generates an evaluation function based on the generated matrix (step S135). In the fourth example embodiment, the evaluation function merging unit 193 generates the evaluation function according to (6) in the process of step S135. The pixel value estimation unit 194 finds x that minimizes the evaluation function by (6) (step S136). In (6), vec(x) is a vector with x converted to a column vector. Finding x that minimizes (6) below corresponds to increasing correlation between the phase based on the observed pixel value and the denoised phase difference, and correlation between pixels after denoising, under the weights based on the coherence matrix and the prior information.

The phase acquisition unit 195 obtains a product of the pixel value in image m and the complex conjugate of the pixel value of the corresponding pixel in image n (refer to (4)), and obtains a phase difference based on the obtained product (step S137). Specifically, the phase acquisition unit 195 obtains the argument of the product (complex conjugate) as the phase difference.

In the fourth example embodiment, the constraint regarding “consistent phase” is satisfied by estimating the phase difference based on the pixel value x after the pixel value x is calculated. Specifically, the constraint is satisfied because the phase difference is calculated again after a certain phase value is assigned to each image.

### Example Embodiment 5

The configuration of the data processing device of the fifth example embodiment may be the same as the configuration of the data processing device 40 of the fourth example embodiment shown in FIG. 8. The operation of the data processing device of the fifth example embodiment may be the same as the operation shown in the flowchart in FIG. 9. However, in the fifth example embodiment, the second evaluation function component generator 192 generates an evaluation function different from the evaluation function in the fourth example embodiment. That is, in the fifth example embodiment, when a spatial correlation matrix isb expressed by Kₙ (n: 1 to N), the second evaluation function component generator 192 generates a diagonal matrix whose elements are Kₙ as shown in equation (7).

$$[ Math . 7 ]$$

$${K}_{G} = ( \begin{matrix}{K}_{1} & 0 & … & 0 \\ 0 & {K}_{2} & & 0 \\ ⋮ & & ⋱ & ⋮ \\ 0 & 0 & … & {K}_{N}\end{matrix} ) \qquad ( 7 )$$

In the fifth example embodiment, as an example, the coherence matrix calculation unit 120 also calculates a coherence matrix from the SAR image stored in the SAR image storage (not shown). However, the coherence matrix calculation unit 120 can calculate a coherence matrix using other information (data) instead of calculating the coherence matrix from the SAR image stored in the SAR image storage.

In the fourth example embodiment, the spatial correlation is assumed to be the same for all of the N images. The fifth example embodiment is useful when it is desired to vary the spatial correlation (in this example, the spatial correlation matrix Kₙ (n: 1 to N)) for each of the N images. In other words, the fifth example embodiment can be used when the spatial correlation of each of the N images is different.

Next, the operation of the data processing device of the fifth example embodiment will be described with reference to the flowchart in FIG. 9.

The coherence matrix calculation unit 120 calculates the coherence matrix Cₚ for N SAR images stored in the SAR image storage as in the fourth example embodiment (step S110).

In the phase estimation unit 190, the first evaluation function component generator 191 generates a matrix for performing evaluation with respect to the observed signal (step S112). In the fifth example embodiment, the first evaluation function component generator 191 generates the matrix, for performing evaluation with respect to the observed signal, which is the second term on the right side of the equation (8) in the process of step S112. In equations (7) and (8), the inverse matrix of Cₚ corresponds to weights based on the coherence matrix at pixel p. The inverse of the spatial correlation matrix Kₙ corresponds to weights based on the prior information.

[Math. 8]

Λ=K_{G}⁻¹+Σₚ(I_{N}⊗eₚ)(Cₚ⁻¹∘y·_{,p}y·_{,p}^{H})(I_{N}⊗eₚ^{T}) (8)

The spatial correlation prediction unit 140 generates (calculates) spatial correlation (in this example, a spatial correlation matrix K) based on prior information regarding the area to be analyzed in the SAR image as in the fourth example embodiment (step S120).

In the phase estimation unit 190, the second evaluation function component generator 192 generates a matrix for evaluating spatial correlation (step S122). In the fifth example embodiment, the second evaluation function component generator 192 generates a block diagonal matrix whose elements (diagonal components) are the spatial correlation matrix Kₙ and generates a matrix, for evaluating the spatial correlation, which is the first term on the right side of the equation (8) in the process of step S112.

The evaluation function merging unit 193 generates an evaluation function based on the generated matrix (step S135). In the fifth example embodiment, the evaluation function merging unit 193 also generates the evaluation function by (6). The pixel value estimation unit 194 finds x that minimizes the above (6) (step S136).

The phase acquisition unit 195 obtains a product of the pixel value in image m and the complex conjugate of the pixel value of the corresponding pixel in image n (refer to (4)), and obtains a phase difference based on the obtained product (step S137). Specifically, the phase acquisition unit 195 obtains the argument of the product (complex conjugate) as the phase difference.

In the fifth example embodiment, the constraint regarding “consistent phase” is satisfied by estimating the phase difference based on the pixel value x after the pixel value x is calculated. Specifically, the constraint is satisfied because the phase difference is calculated again after a certain phase value is assigned to each image.

### Example Embodiment 6

FIG. 10 is a block diagram showing an example configuration of the data processing device of the sixth example embodiment. The data processing device 50 shown in FIG. 10 includes the coherence matrix calculation unit 120, the spatial correlation prediction unit 140, and a phase estimation unit 200. The phase estimation unit 200 includes a first evaluation function component generator 201, a second evaluation function component generator 202, an evaluation function merging unit 203, a pixel value estimation unit 204, and a phase acquisition unit 205.

In the sixth example embodiment, as an example, the coherence matrix calculation unit 120 also calculates a coherence matrix from the SAR image stored in the SAR image storage (not shown). However, the coherence matrix calculation unit 120 can calculate a coherence matrix using other information (data) instead of calculating the coherence matrix from the SAR image stored in the SAR image storage.

In the phase estimation unit 200, the first evaluation function component generator 201 generates a matrix, for performing evaluation with respect to the observed signal, which is the second term on the right side of the above equation (5). The second evaluation function component generator 202 generates a matrix, for evaluating the spatial correlation, which is the first term on the right side of the equation (5).

In the sixth example embodiment, equation (5) is used as in the case of the fourth example embodiment, however in the sixth example embodiment, the concept of the fifth example embodiment may be applied and equation (8) may be used.

The evaluation function merging unit 203 merges the matrix for performing evaluation with respect to the observed signal and the matrix for evaluating the spatial correlation, tr(ΛX^{H}) “tr” is the trace (summation of diagonal components of the matrix). The pixel value estimation unit 204 finds X that minimizes the value of a given evaluation equation. The phase acquisition unit 205 obtains the phase difference based on X.

X is a matrix corresponding to (9) below. However, while the matrix X calculated in (9) always has rank 1, it may be a matrix with less rank described below as the matrix X in this example embodiment.

[Math. 9]

vec(x)vec(x)^{H} (9)

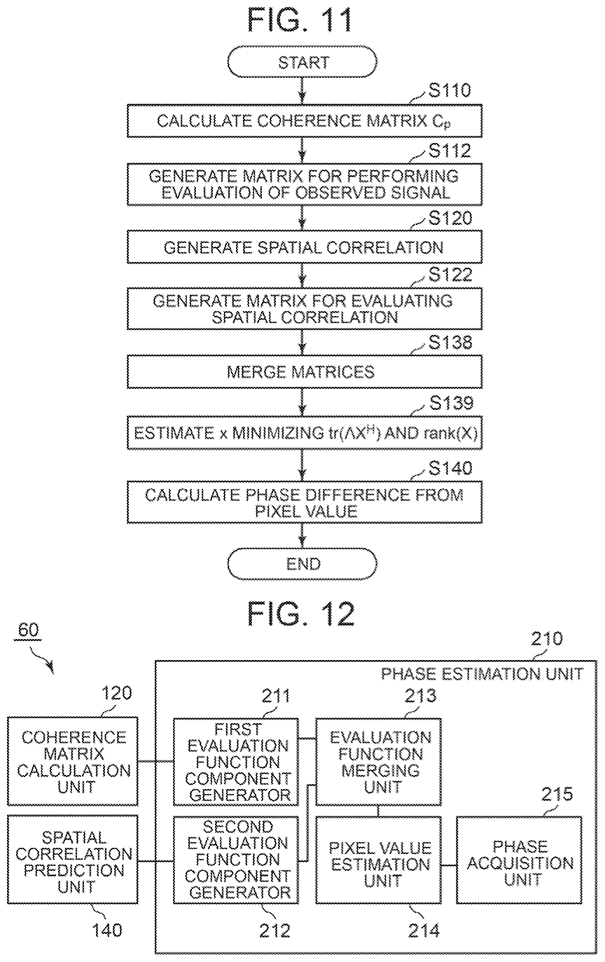

Next, the operation of the data processing device of the sixth example embodiment will be described with reference to the flowchart in FIG. 11.

The coherence matrix calculation unit 120 calculates the coherence matrix Cₚ for N SAR images stored in the SAR image storage, as in the fourth example embodiment, etc. (step S110).

In the phase estimation unit 200, the first evaluation function component generator 201 generates a matrix for performing evaluation with respect to the observed signal (step S112). the first evaluation function component generator 201 generates the matrix, for performing evaluation with respect to the observed signal, which is the second term on the right side of the above equation (5) in the process of step S112.

The spatial correlation prediction unit 140 generates (calculates) spatial correlation (in this example, a spatial correlation matrix K) based on prior information regarding the area to be analyzed in the SAR image as in the fourth example embodiment (step S120).

In the phase estimation unit 200, the second evaluation function component generator 202 generates a matrix for evaluating spatial correlation (step S122). The second evaluation function component generator 202 generates a matrix, for evaluating the spatial correlation, which is the first term on the right side of the equation (5) in the process of step S112.

The evaluation function merging unit 203 merges the generated matrices to obtain tr(ΛX^{H}) (step S138).

The pixel value estimation unit 204 finds X that minimizing tr(ΛX^{H}) and rank(X) (step S139). “rank” is a rank of the matrix. It should be noted that finding the X that minimizes tr(ΛX^{H}) and rank(X) corresponds to increasing correlation between the phase based on the observed pixel value and the denoised phase difference, and correlation between pixels after denoising, under the weights based on the coherence matrix and the prior information.

The phase acquisition unit 205 obtains a phase difference based on the obtained X, i.e., estimated X and the following (10) (step S140). Specifically, the phase acquisition unit 195 obtains the argument of the product (complex conjugate) as the phase difference.

[Math. 10]

X_{(m-1)N+p,(n-1)N+p} (10)

As described above, “consistent phase” is defined to mean that the values are consistent when the phase difference is recalculated from any other combination of phase differences. In other words, the constraint of “consistent phase” is defined to be that the calculation results are consistent no matter what combination of phase differences are calculated from. In the sixth example embodiment, by estimating X that minimizes tr(ΛX^{H}) and rank (X), as a result, the constraint of “consistent phase” is relaxed.

### Example Embodiment 7

FIG. 12 is a block diagram showing an example configuration of a data processing device of the seventh example embodiment. The data processing device 60 shown in FIG. 12 includes the coherence matrix calculation unit 120, the spatial correlation prediction unit 140, and a phase estimation unit 210. The phase estimation unit 210 includes a first evaluation function component generator 211, a second evaluation function component generator 212, an evaluation function merging unit 213, a pixel value estimation unit 214, and a phase acquisition unit 215.

In the seventh example embodiment, as an example, the coherence matrix calculation unit 120 also calculates a coherence matrix from the SAR image stored in the SAR image storage (not shown). However, the coherence matrix calculation unit 120 can calculate a coherence matrix using other information (data) instead of calculating the coherence matrix from the SAR image stored in the SAR image storage.

In the seventh example embodiment, in the phase estimation unit 210, the first evaluation function component generator 211 generates a matrix, for performing evaluation with respect to the observed signal, which is the second term on the right side of the above equation (11). The second evaluation function component generator 212 generates a matrix, for evaluating the spatial correlation, which is the first term on the right side of the equation (11).

[Math. 11]

A=I_{N}⊗D⁻¹+Σₚ(Cₚ⁻¹∘y·_{,p}y·_{,p}^{H})⊗(uₚuₚ^{H}) (11)

In the seventh example embodiment, when generating the matrix, for evaluating the spatial correlation, of the first term on the right side of the equation (11), at first, the second evaluation function component generator 212 reduced-dimensional decomposes the spatial correlation matrix K using equation (12). As such an approximation, for example, a method called Nystrom approximation may be used. That is, a random and non-duplicated integer sequence whose maximum value is the number of rows of K is generated, and a matrix U may be formed by taking only the vectors of rows corresponding to the integer sequence and arranging them, in addition, a matrix D, which is an inverse matrix of a matrix formed by taking only the vectors of columns corresponding to the integer sequence from U and arranging them, may be formed. Alternatively, U may be formed by performing singular value decomposition and arranging singular vectors of upper singular values, in addition, D may be formed as a diagonal matrix in which upper singular values are arranged as diagonal elements.

[Math. 12]

K≃UDU^{T} (12)

In equations (11) and (12), D is a d×d matrix (d<N), and U is an N×d matrix (U=u₁, u₂, . . . , u_{d}).

The evaluation function merging unit 213 generates an evaluation function based on the generated matrix. The pixel value estimation unit 214 finds x that minimizes the value of the evaluation function. The phase acquisition unit 215 obtains a phase difference based on x.

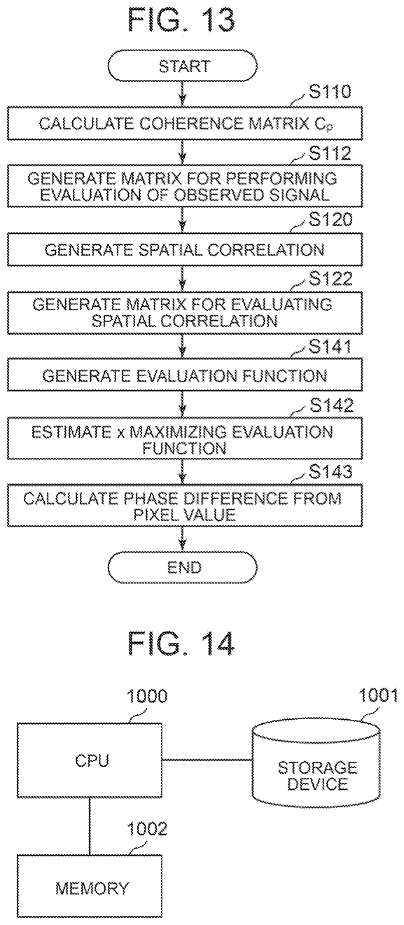

Next, the operation of the data processing device of the seventh example embodiment will be described with reference to the flowchart in FIG. 13.

The coherence matrix calculation unit 120 calculates the coherence matrix Cₚ for N SAR images stored in the SAR image storage, as in the fourth example embodiment, etc. (step S110).

In the phase estimation unit 210, the first evaluation function component generator 211 generates a matrix for performing evaluation with respect to the observed signal (step S112). In the seventh example embodiment, the first evaluation function component generator 211 generates the matrix, for performing evaluation with respect to the observed signal, which is the second term on the right side of the equation (11) in the process of step S112.

The spatial correlation prediction unit 140 generates (calculates) spatial correlation (in this example, a spatial correlation matrix K) based on prior information regarding the area to be analyzed in the SAR image as in the fourth example embodiment (step S120).

In the phase estimation unit 210, the second evaluation function component generator 212 generates a matrix for evaluating spatial correlation after reduced-dimensional decomposing the spatial correlation matrix K (step S122). In the seventh example embodiment, the second evaluation function component generator 212 generates a matrix, for evaluating the spatial correlation, which is the first term on the right side of the equation (11) in the process of step S112.

The evaluation function merging unit 213 generates an evaluation function based on the generated matrix (step S141). In the seventh example embodiment, the evaluation function merging unit 213 generates the evaluation function according to (13).

[Math. 13]

−vec(x)^{H}(I_{N}⊗U^{T})vec(x) (13)

The pixel value estimator 214 finds x that minimizes the evaluation function (step S142).

The phase acquisition unit 215 obtains a phase difference based on the obtained x, i.e., estimated x and the above (4) (step S140). Specifically, the phase acquisition unit 215 obtains the argument of the product (complex conjugate) as the phase difference.

In the seventh example embodiment, the constraint regarding “consistent phase” is satisfied by estimating the phase difference based on the pixel value x after the pixel value x is calculated. Specifically, the constraint is satisfied because the phase difference is calculated again after a certain phase value is assigned to each image.

In addition, in the seventh example embodiment, since the second evaluation function component generator 212 reduces the number of dimensions of the spatial correlation matrix K, it is possible to reduce the amount of operations regarding the spatial correlation matrix which requires especially large amount of operations. As a result, for example, when the data processing device is realized by a computer (processor), the time required for processing is reduced.

The following modifications can also be conceivable.

The spatial correlation matrix K is defined as the Kronecker product of the longitudinal and transverse correlations. When the spatial correlation matrix K is defined as such, the reduced-dimensional decomposition of the spatial correlation matrix K can be efficiently calculated by combining the reduced-dimensional decomposition in the x and y directions.

The spatial correlation matrix K is defined by a function, etc. whose analytic Fourier transform is known, such as a Gaussian function. When the correlation matrix K is defined as such, the accuracy of the phase difference after dimensionality reduction can be guaranteed by determining the number of dimensions to be compressed using prior knowledge of the bandwidth when performing the reduced-dimensional decomposition of the correlation matrix K.

The spatial correlation matrix K is defined in such a way as cyclic. When the spatial correlation matrix K is defined as such, the spatial correlation matrix K can be calculated by efficient calculation based on FFT (Fast Fourier Transform). It should be noted that “a way as cyclic” means a manner in which the top and bottom of the image are connected.

Each component in each of the above example embodiments may be configured with a single piece of hardware, but can also be configured with a single piece of software. Alternatively, the components may be configured with a plurality of pieces of hardware or a plurality of pieces of software. Further, part of the components may be configured with hardware and the other part with software.

The functions (processes) in the above example embodiments may be realized by a computer having a processor such as a central processing unit (CPU), a memory, etc. For example, a program for performing the method (processing) in the above example embodiments may be stored in a storage device (storage medium), and the functions may be realized with the CPU executing the program stored in the storage device.

FIG. 14 is a block diagram showing an example of a computer having a CPU. The computer is implemented in the data processing device. The CPU 1000 executes processing in accordance with a program (software component: codes) stored in a storage device 1001 to realize the functions in the above example embodiments. That is to say, the functions of the coherence matrix calculation unit 120, the spatial correlation prediction unit 140, the phase estimation units 160, 170, 180, 90, 200, 210 in the data processing devices shown in FIG. 1, FIG. 4, FIG. 6, FIG. 8, FIG. 10, FIG. 12.

The storage device 1001 is, for example, a non-transitory computer readable media. The non-transitory computer readable medium is one of various types of tangible storage media. Specific examples of the non-transitory computer readable media include a magnetic storage medium (for example, hard disk), a magneto-optical storage medium (for example, magneto-optical disk), a compact disc-read only memory (CD-ROM), a compact disc-recordable (CD-R), a compact disc-rewritable (CD-R/W), and a semiconductor memory (for example, a mask ROM, a PROM (programmable ROM), an EPROM (erasable PROM), a flash ROM). The storage device 1001 can also be used as the SAR image storage.

The program may be stored in various types of transitory computer readable media. The transitory computer readable medium is supplied with the program through, for example, a wired or wireless communication channel, i.e., through electric signals, optical signals, or electromagnetic waves.

A memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

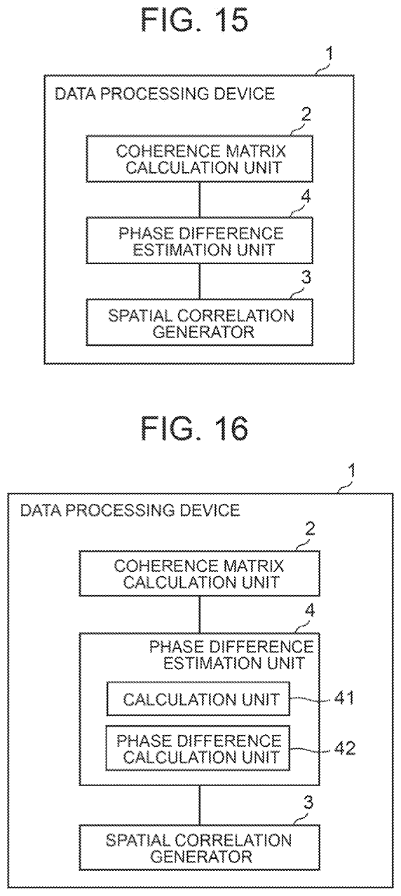

FIG. 15 is a block diagram showing the main part of the data processing device. The data processing device 1 shown in FIG. 15 comprises a coherence matrix calculation unit (coherence matrix calculation means) 2 (in the example embodiments, realized by the coherence matrix calculation unit 120) which calculates a coherence matrix representing correlation of pixels at the same position in multiple complex images, a spatial correlation generator (spatial correlation generation means) 3 (in the example embodiments, realized by the spatial correlation prediction unit 140) which generates data representing prior information regarding spatial correlation being correlation of pixels in each of the multiple complex images, and a phase difference estimation unit (phase difference estimation means) 4 (in the example embodiments, realized by the phase estimation unit 160, 170, 180, 190, 200, 210) which merges the correlation of pixels regarding the coherence matrix and the spatial correlation, and calculates a statistically likely and consistent phase difference based on merged correlation as a denoised phase difference.

FIG. 16 is a block diagram showing the main part of another type of data processing device. In the data processing device 1 shown in FIG. 16, the phase difference estimation unit 4 estimates includes a calculation unit (calculation means) 41 (in the example embodiments, realized by the phase calculation unit 173, and the pixel value estimation unit 184, 194, 204, 214) which increases correlation between the phase based on observed pixel value and the denoised phase difference, and correlation between pixels after denoising, under a weight based on the coherence matrix and a weight based on the prior information, and a phase difference calculation unit (phase difference calculation means) 42 (in the example embodiments, realized by the phase calculation unit 173, and the phase acquisition unit 185, 195, 205, 215) which calculates the phase difference from a calculation result.

A part of or all of the above example embodiments may also be described as, but not limited to, the following supplementary notes.

(Supplementary note 1) A data processing device comprising:
coherence matrix calculation means for calculating a coherence matrix representing correlation of pixels at the same position in multiple complex images;
spatial correlation generation means for generating data representing prior information regarding spatial correlation being correlation of pixels in each of the multiple complex images; and
phase difference estimation means for merging the correlation of pixels regarding the coherence matrix and the spatial correlation, and calculating a statistically likely and consistent phase difference based on merged correlation as a denoised phase difference.

(Supplementary note 2) The data processing device according to Supplementary note 1, wherein
the consistent phase difference is a phase difference that all calculation results are consistent when the phase difference is calculated from any combination of phase differences.

(Supplementary note 3) The data processing device according to Supplementary note 1 or 2, wherein the phase difference estimation means includes
calculation means for increasing correlation between the phase based on observed pixel value and the denoised phase difference, and correlation between pixels after denoising, under a weight based on the coherence matrix and a weight based on the prior information, and
phase difference calculation means for calculating the phase difference from a calculation result.

(Supplementary note 4) The data processing device according to Supplementary note 3, wherein
the phase difference estimation means generates a evaluation function representing the merged correlation,
the calculation means obtains a pixel value, as the calculation result, which maximizes the evaluation function as the denoised pixel, and
the phase difference calculation means calculates the phase difference from the pixel value.

(Supplementary note 5) The data processing device according to any one of Supplementary notes 1 to 4, wherein
the spatial correlation generation means generates a spatial correlation matrix as the data representing the prior information.

(Supplementary note 6) The data processing device according to Supplementary note 5, wherein
the phase difference estimation means includes means for reduced-dimensional decomposing the spatial correlation matrix.

(Supplementary note 7) The data processing device according to any one of Supplementary notes 1 to 6, comprising a memory storing a software component (codes) and a processor realizes the coherence matrix calculation means, the spatial correlation generation means, and the phase difference estimation means according to the software component stored in the memory.

(Supplementary note 8) A data processing method comprising:
calculating a coherence matrix representing correlation of pixels at the same position in multiple complex images;
generating data representing prior information regarding spatial correlation being correlation of pixels in each of the multiple complex images; and
merging the correlation of pixels regarding the coherence matrix and the spatial correlation, and calculating a statistically likely and consistent phase difference based on merged correlation as a denoised phase difference.

(Supplementary note 9) The data processing method according to Supplementary note 8, wherein
the consistent phase difference is a phase difference that all calculation results are consistent when the phase difference is calculated from any combination of phase differences.

(Supplementary note 10) The data processing method according to Supplementary note 8 or 9, further comprising
increasing correlation between the phase based on observed pixel value and the denoised phase difference, and correlation between pixels after denoising, under a weight based on the coherence matrix and a weight based on the prior information, and
calculating the phase difference from a calculation result.

(Supplementary note 11) The data processing method according to Supplementary note 10, further comprising
generating a evaluation function representing the merged correlation,
obtaining a pixel value, as the calculation result, which maximizes the evaluation function as the denoised pixel, and
calculating the phase difference from the pixel value.

(Supplementary note 12) The data processing method according to any one of Supplementary notes 8 to 11, implemented by a processor.

(Supplementary note 13) A data processing program causing a computer to execute a process of calculating a coherence matrix representing correlation of pixels at the same position in multiple complex images, a process of generating data representing prior information regarding spatial correlation being correlation of pixels in each of the multiple complex images and a process of merging the correlation of pixels regarding the coherence matrix and the spatial correlation, and calculating a statistically likely and consistent phase difference based on merged correlation as a denoised phase difference.

(Supplementary note 14) The data processing program according to Supplementary note 13, causing the computer to further execute a process of increasing correlation between the phase based on observed pixel value and the denoised phase difference, and correlation between pixels after denoising, under a weight based on the coherence matrix and a weight based on the prior information, and a process of calculating the phase difference from a calculation result.

(Supplementary note 15) The data processing program according to Supplementary note 14, causing the computer to further execute a process of generating a evaluation function representing the merged correlation,
a process of obtaining a pixel value, as the calculation result, which maximizes the evaluation function as the denoised pixel, and
a process of calculating the phase difference from the pixel value.

(Supplementary note 16) A computer readable recording medium storing a data processing program, wherein
the data processing program causes a computer to execute:
a process of calculating a coherence matrix representing correlation of pixels at the same position in multiple complex images;
a process of generating data representing prior information regarding spatial correlation being correlation of pixels in each of the multiple complex images; and
a process of merging the correlation of pixels regarding the coherence matrix and the spatial correlation, and calculating a statistically likely and consistent phase difference based on merged correlation as a denoised phase difference.

(Supplementary note 17) The recording medium according to Supplementary note 16, wherein
the data processing program causes the computer to further execute
a process of increasing correlation between the phase based on observed pixel value and the denoised phase difference, and correlation between pixels after denoising, under a weight based on the coherence matrix and a weight based on the prior information, and
a process of calculating the phase difference from a calculation result.

(Supplementary note 18) The recording medium according to Supplementary note 17, wherein
the data processing program causes the computer to further execute
a process of generating a evaluation function representing the merged correlation,
a process of obtaining a pixel value, as the calculation result, which maximizes the evaluation function as the denoised pixel, and
a process of calculating the phase difference from the pixel value.

Although the invention of the present application has been described above with reference to example embodiments, the present invention is not limited to the above example embodiments. Various changes can be made to the configuration and details of the present invention that can be understood by those skilled in the art within the scope of the present invention.

### REFERENCE SIGNS LIST

1 Data processing device
2 Coherence matrix calculation unit
3 Spatial correlation generator
4 Phase difference estimation unit
10, 20, 30, 40, 50, 60 Data processing device
41 Calculation unit
42 Phase difference calculation unit
120 Coherence matrix calculation unit
140 Spatial correlation prediction unit
160, 170, 180, 190, 200, 210 190, 200, 210 Phase estimation unit
171, 181 First evaluation function generator
191, 201, 211 First evaluation function component generator
172, 182 Second evaluation function generator
192, 202, 212 Second evaluation function component generator
173 Phase calculation unit
183, 193, 203, 213 Evaluation function merging unit
184, 194, 204, 214 Pixel value estimation unit
185, 195, 205, 215 Phase acquisition unit
1000 CPU
1001 Storage device
1002 Memory

What is claimed is:

1. A data processing device comprising:
a memory storing software instructions, and
one or more processors configured to execute the software instructions to
calculate a coherence matrix representing correlation of pixels at the same position in multiple complex images;
generate data representing prior information regarding spatial correlation being correlation of pixels in each of the multiple complex images; and
merge the correlation of pixels regarding the coherence matrix and the spatial correlation, and calculate a statistically likely and consistent phase difference based on merged correlation as a denoised phase difference.

2. The data processing device according to claim 1, wherein
the consistent phase difference is a phase difference that all calculation results are consistent when the phase difference is calculated from any combination of phase differences.

3. The data processing device according to claim 1, wherein the one or more processors are configured to execute the software instructions to
increase correlation between the phase based on observed pixel value and the denoised phase difference, and correlation between pixels after denoising, under a weight based on the coherence matrix and a weight based on the prior information, and
calculate the phase difference from a calculation result.

4. The data processing device according to claim 3, wherein
the one or more processors are configured to execute the software instructions to generate a evaluation function representing the merged correlation,
obtain a pixel value, as the calculation result, which maximizes the evaluation function as the denoised pixel, and
calculate the phase difference from the pixel value.

5. The data processing device according to claim 1, wherein
the one or more processors are configured to execute the software instructions to generate a spatial correlation matrix as the data representing the prior information.

6. The data processing device according to claim 5, wherein
the one or more processors are configured to execute the software instructions to reduced-dimensional decompose the spatial correlation matrix.

7. A data processing method, implemented by a processor, comprising:
calculating a coherence matrix representing correlation of pixels at the same position in multiple complex images;
generating data representing prior information regarding spatial correlation being correlation of pixels in each of the multiple complex images; and
merging the correlation of pixels regarding the coherence matrix and the spatial correlation, and calculating a statistically likely and consistent phase difference based on merged correlation as a denoised phase difference.

8. The data processing method, implemented by a processor, according to claim 7, wherein
the consistent phase difference is a phase difference that all calculation results are consistent when the phase difference is calculated from any combination of phase differences.

9. The data processing method, implemented by a processor, according to claim 7, further comprising
increasing correlation between the phase based on observed pixel value and the denoised phase difference, and correlation between pixels after denoising, under a weight based on the coherence matrix and a weight based on the prior information, and
calculating the phase difference from a calculation result.

10. The data processing method, implemented by a processor, according to claim 9, further comprising
generating a evaluation function representing the merged correlation,
obtaining a pixel value, as the calculation result, which maximizes the evaluation function as the denoised pixel, and
calculating the phase difference from the pixel value.

11. A non-transitory computer readable recording medium storing a data processing program, wherein
the data processing program causes a computer to execute:
a process of calculating a coherence matrix representing correlation of pixels at the same position in multiple complex images;
a process of generating data representing prior information regarding spatial correlation being correlation of pixels in each of the multiple complex images; and
a process of merging the correlation of pixels regarding the coherence matrix and the spatial correlation, and calculating a statistically likely and consistent phase difference based on merged correlation as a denoised phase difference.

12. The non-transitory computer readable recording medium according to claim 11, wherein
the data processing program causes the computer to further execute
a process of increasing correlation between the phase based on observed pixel value and the denoised phase difference, and correlation between pixels after denoising, under a weight based on the coherence matrix and a weight based on the prior information, and
a process of calculating the phase difference from a calculation result.

13. The non-transitory computer readable recording medium according to claim 12, wherein
the data processing program causes the computer to further execute
a process of generating a evaluation function representing the merged correlation,
a process of obtaining a pixel value, as the calculation result, which maximizes the evaluation function as the denoised pixel, and
a process of calculating the phase difference from the pixel value.
